(19) United States
(12) Patent Application Publication
(10) Pub. No.: US 2004/0123287 A1
(43) Pub. Date: Jun. 24, 2004

(54) System and method for installation and Integration of component datamodels

(75) Inventors: James E. Fox, Apex, NC (US); Niraj P. Joshi, Cary, NC (US); Robert C. Leah, Cary, NC (US); Erich S. Magee, Morrisville, NC (US); Robert C. Sizemore, Fuquay-Varina, NC (US); Paul F. McMahan, Apex, NC (US)

Correspondence Address: Gerald R. Woods, IBM Corporation T81/503, PO Box 12195, Research Triangle Park, NC, 27709, US

(73) Assignee: International Business Machines Corporation, Armonk, NY

(21) Appl. No.: 10/324,280

(22) Filed: Dec. 19, 2002

(51) Int. Cl. G06F 9/445; G06F 9/44

(52) U.S. Cl. 717/176; 717/171

(57) ABSTRACT

A system and method that provides platform independent retrieval of software component data is provided. The discovered system and method manage conflicts, co-requisites, and pre-requisites associated with installing a software component by including such information in a software description which is retrieved in a platform-neutral manner. The system and method can be initiated by the target computer system or it can be driven by a application server that connects to the target computer system through a computer network. In a target initiated environment, the target computer system resolves conflict and co-/pre-requisite issues identified in the component description before installing the component software. In a server-initiated process, the server resolves the identified conflict and co-/pre-requisite issues on behalf of the target system and installs the software component on the target system.

### BACKGROUND OF THE INVENTION

1. Technical Field

The present invention relates in general to a system and method for installing software component. More particularly, the present invention relates to a system and method for using platform neutral software modules for providing software installation information over a computer network.

2. Description of the Related Art

Installation of software components is challenging due to the complexities regarding modern software products. Various hardware and software platforms, such as Microsoft Windows XP™, Linux™, and IBM's AIX™ operating systems each have different installation procedures. In addition, a particular software component may have known conflicts, such as other software components, that need to be resolved before installation.

In addition, software components are increasingly complex in terms of co-requisite and pre-requisite software components that are either recommended or required to be installed beforehand. Other information regarding software components, such as certification levels and licensing information, also needs to be considered before installing the software component.

Software components that are installed incorrectly may cause data loss or other damage to the client, or target, computer system. Moreover, traditional software installation procedures are platform dependent. Installation data provided for one platform is not readily available from another platform without porting the data to the other platform environment. In addition, platform dependence limits the re-use of custom code and configuration data used for the integration of complex software components.

What is needed, therefore, is a system and method that provides platform independent retrieval of software component data. Furthermore, what is needed is a system and method to manage conflicts, co-requisites, and pre-requisites associated with installing a software component. Finally, what is needed is a system and method that can be initiated by the client, or target, computer system or can be driven by a application server that connects to the target computer system through a computer network.

### SUMMARY

It has been discovered that the aforementioned challenges are resolved by a system and method that provides platform independent retrieval of software component data. The discovered system and method manage conflicts, co-requisites, and pre-requisites associated with installing a software component by including such information in a software description which is retrieved in a platform-neutral manner utilizing enterprise Java beans. The system and method can be initiated by the target computer system or it can be driven by a application server that connects to the target computer system through a computer network.

In a target initiated environment, the target sends a platform neutral request to a Web application server for a particular software component. The Web application server retrieves a Java bean home interface for the requested software component. The home interface identifies a Java bean that is used by the Web application server to retrieve a description of the software component. The description includes conflict, co-requisite/pre-requisite information, as well as other information such as certification information and licensing information. The software description is returned to the target in platform neutral response.

The Web application server gathers files needed to install the requested software component from one or more Web-based files servers and stores the gathered files in a nonvolatile storage area. The files are gathered in anticipation of the target computer system requesting the component files.

While the Web application server is gathering the component files, the target computer analyzes the component description, resolves any conflicts, and requests and co- and pre-requisite software components. The co- and pre-requisite software components may also have conflicts that need to be resolved and may also have co- and pre-requisite components. The target requests and receives the component files from the Web application server and installs the software component on the target computer system.

In a server-initiated process, the target registers with a software assembler Web service by providing the software assembler Web service with information, such as host names, passwords, etc. needed by the software assembler Web service to automatically install the software component on the target computer system. The software assembler Web service registers the component request with a Java Message Service hosted by an enterprise application server. When the requested component is modified, the Java Message Service informs the software assembler Web service which responds by retrieving the software description and resolving any conflict and co-/pre-requisite issues on behalf of the target computer system. The software assembler Web service gathers the component files needed for installation from Web file servers and installs the software component on the target computer system using the access information that was provided during registration.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 shows a block diagram of a Web application server communicating with an enterprise application server to deliver component files to an installation target;

FIG. 2 shows a block diagram and flowchart of an installation target requesting software components including pre-requisite and co-requisite software components;

FIG. 3 shows a block diagram of a Web application server initiating the delivery of component files to an installation target;

FIG. 4 shows a flowchart of a target initiated process requesting a software component and any pre-requisite or co-requisite software components;

FIG. 5 shows a flowchart of a Web service initiated process monitoring software components and installing a software component and any pre-requisite or co-requisite software components;

FIG. 6 shows a network diagram of network nodes that interact to provide component installation services for a target computer system; and

FIG. 7 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

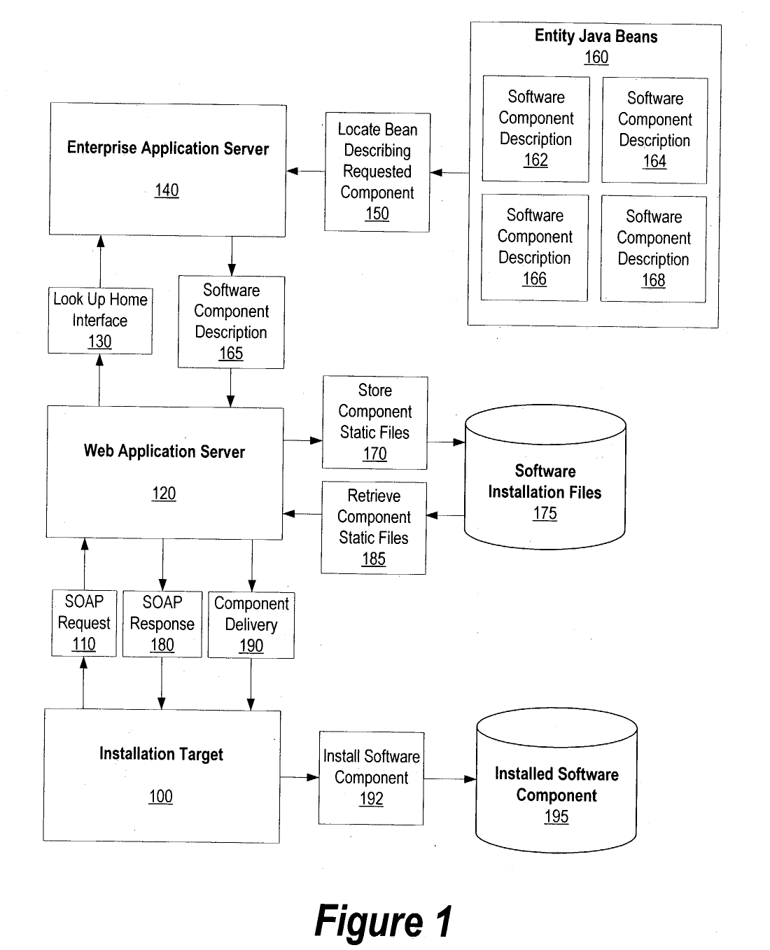

FIG. 1 shows a block diagram of a Web application server communicating with an enterprise application server to deliver component files to an installation target. Installation target 100 is a computer system, such as a IBM compatible personal computer, that is connected to a network, such as the Internet. Installation target 100 sends SOAP request 110 to Web application server 120 over the computer network. SOAP request 110 is a request created using the Simple Object Access Protocol which provides a way for applications to communicate with each other over the computer network, such as the Internet. The SOAP protocol is used to communicate between applications independent of the operating system platform being used by the individual computer systems. SOAP relies on XML to define the format of the information and then adds necessary HTML headers to send it to the other computer system. The SOAP request sent from installation target 100 to Web application server 120 is a request for a particular software component. The requested software component could be a major software package such as IBM's WebSphere(tm) or Lotus Notes(tm), or it could be an auxiliary resource such as a configuration file or an SQL script used to support an installation procedure. Web application server 120 receives the SOAP request 110 and contacts enterprise application server 140 and looks up home interface 130 for the Software Assembler entity bean via a Java Naming and Directory Interface (JNDI).

Enterprise application server 140 locates the Java bean that describes the requested software component using process 150. Entity Java beans 160 includes a number of beans, each of which correspond to a different software component. Each of the beans including method that can be called to return a description of the corresponding software component. The description includes the list of the files that are needed to install the software component. The description also includes other software components that are pre-requisites, co-requisites, and conflicts of the corresponding software component. Other information about the software component, such as supported hardware platforms, supported operating system platforms, certification levels, and licensing information can also be included in the description information.

In the example shown, entity Java beans 160 is a library of Java beans that include Java bean 162, 164, 166, and 168. Each of the Java beans includes a method that describes the corresponding software component. Software component description 165 corresponding to the requested software component is returned from enterprise application server 140 to Web application server 120. Web application server 120 creates a SOAP response 180 that is returned to installation target 100. The SOAP response 180 details the files needed to install the software component, as well as other software components that are co-requisites or pre-requisites for installing the requested software component. Web application server 120 receives static files that correspond to the requested software component. These static files are stored using process 170 in nonvolatile data storage area 175 that is accessible from the Web application server. The files are stored in anticipation of the installation target requesting the component files. Web application server 120 receives the component files from one or more Web, file servers that may or may not be associated with enterprise application server 140.

Installation target 100 requests the component files from Web application server 120. Prior to requesting the files, installation target 100 resolves any conflicts that may exist between the requested component and the installation target's present configuration and also request any pre-requisite or co-requisite software components. Pre-requisite software components are requested, using additional SOAP requests, and pre-requisite component files are installed prior to receiving the requested component files. Web application server 120 receives component file requests from installation target 100 and retrieves component static files from nonvolatile storage area 175 using process 185. The retrieved component files are delivered to installation target 100 through data stream 190. Installation target 100 uses the received component files to install the requested software component using process 192 whereupon the requested software component is installed on nonvolatile storage device 195 accessible by the installation target.

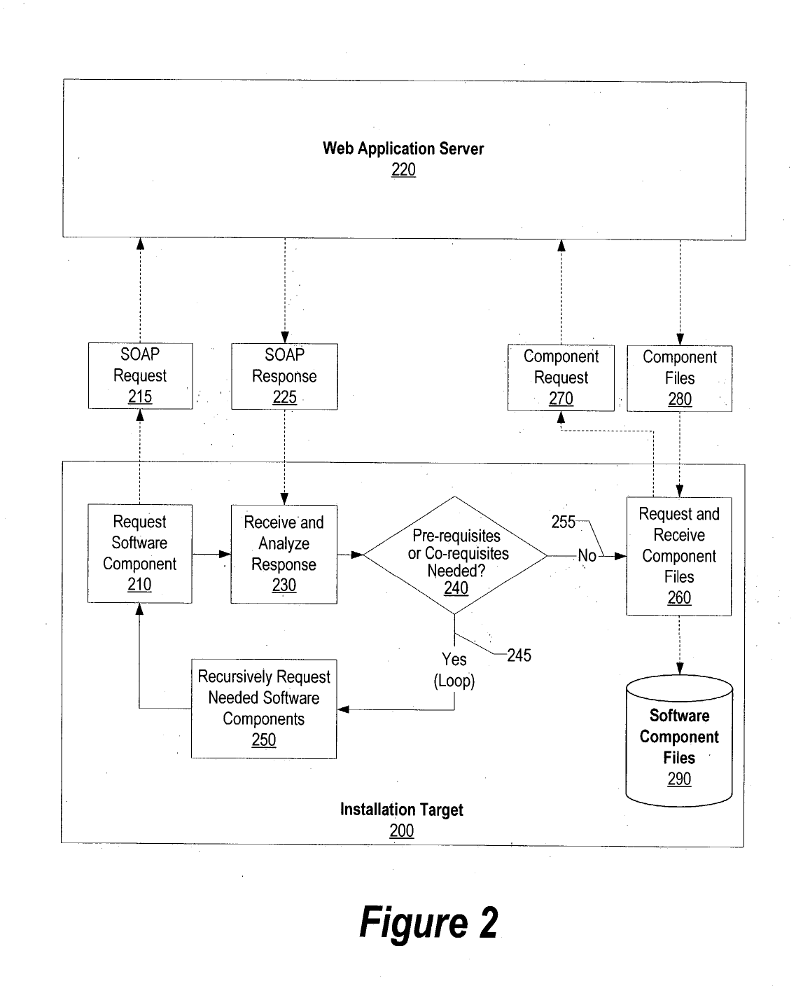

FIG. 2 shows a block diagram and flowchart of an installation target requesting software components including pre-requisite and co-requisite software components. Installation target 200 request software component (step 210) by creating SOAP request 215 and sending it to application server 220. Web application server 220 retrieves a description of the requested software component. This description, as described in FIG. 1, includes the list of the files corresponding to the component, conflict information, and pre-requisite/co-requisite information. Web application server 220 creates SOAP response 225 detailing the requested software component description. SOAP response 225 is sent from the Web application server back to the installation target. Installation target 200 receives and analyzes the SOAP response (step 230).

A determination is made by the installation target as to whether any pre-requisite or co-requisites are needed (decision 240). If pre-requisites/co-requisites are needed, decision 240 branches to “yes” branch 245 whereupon the pre-requisite/co-requisite software components are requested (step 250) and processing loops back to process SOAP responses corresponding to the pre-requisite/co-requisite software components. Pre-requisites and co-requisites may also have their own list of pre-requisites and co-requisites. The SOAP responses for these pre-requisites and co-requisites are also analyzed and additional pre-requisites and co-requisites are requested until no more pre-requisites and co-requisites are needed. When all needed to pre-requisites and co-requisites have been requested, decision 240 branches to “no” branch 255 whereupon installation target 200 requests and receives the software component files (step 260). Web application server 220 receives component file request 270, retrieves requested file, and returns the requested component files 280 to installation target 200. Installation target 200 uses the received component files to install the requested software component 290 onto a nonvolatile storage device accessible by installation target.

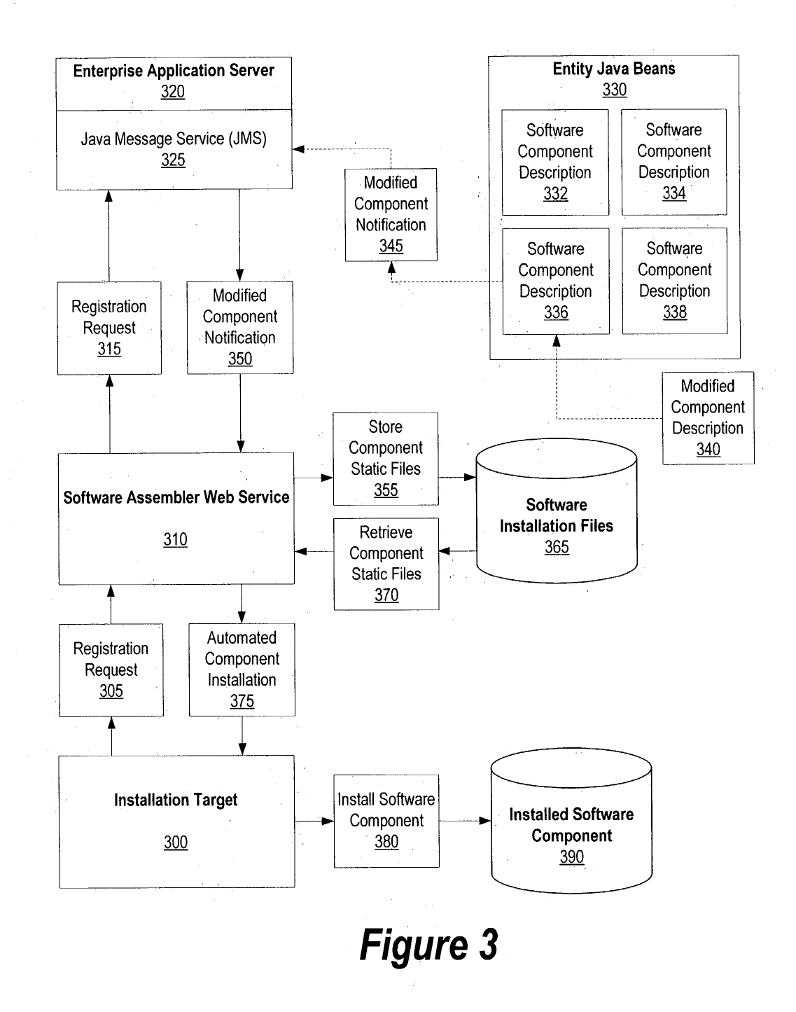

FIG. 3 shows a block diagram of a Web application server initiating the delivery of component files to an installation target. Installation target 300 sends registration request 305 to software assembler Web service 310. Registration request 305 corresponds to a software component or category of software in which the installation target is interested. Registration request 305 also includes a hostname, such as a server used by the installation target, authentication credentials that uniquely identifies installation target, and other information that may be necessary to automatically drive installation on the installation target. Software assembler Web service 310 sends registration request 315 to Java Message Service (JMS) component 325 running on enterprise application server 320. JMS component 325 monitors a collection of software component descriptions stored in entity Java beans library 330. In the example shown, the collection of software component descriptions includes software component descriptions 332, 334, 336, and 338. These software component descriptions are included in Enterprise Java beans, wherein each Enterprise Java bean corresponds to a different software component. In the example shown, software component description 336 is modified using modified component description 340. An example of a modified component description could be a new or modified file that is used by the software component. When a software component description is modified, JMS 325 is notified. In the example shown, modified component notification 345 is identified by JMS 325 wherein software component description 336 is modified.

When a software component description is modified, JMS 325 sends modified component notification 350 to software assembler Web service 310. This notification is sent because the software assembler Web service previously registered to be notified when the software description was modified with registration request 315. Software assembler Web service 310 receives software component files needed to install the software component. These files are stored (process 355) in nonvolatile storage area 365 accessible by the software assembler Web service. The software assembler Web service receives the component files from one or more file servers that may or may not be associated with enterprise application server 320. In addition, software assembler Web service determines whether there any conflicts, pre-requisites, or co-requisites to resolve on behalf of installation target 300. Pre-requisite and co-requisite software components are requested and installed on installation target 300 by software assembler Web service 310. Once conflicts, pre-requisites, and co-requisites are resolved, software assembler Web service 310 retrieves component files (process 370) from nonvolatile storage area 365. Software assembler Web service 310 installs the component files onto installation target 300 by accessing installation target 300 using a method established with registration request 305. For example, during the registration process, installation target 300 may have provided software assembler Web service 310 with access to the installation target by providing passwords or by providing a host, or server, that has access to the installation target. Software assembler Web service 310 performs automated component installation (process 375) which results in installation of a software component (process 380) to nonvolatile storage area 390 which is accessible from the installation target. In addition, platform information, such as an operating system registry, are updated by installation target 300 to reflect the installation of the software component.

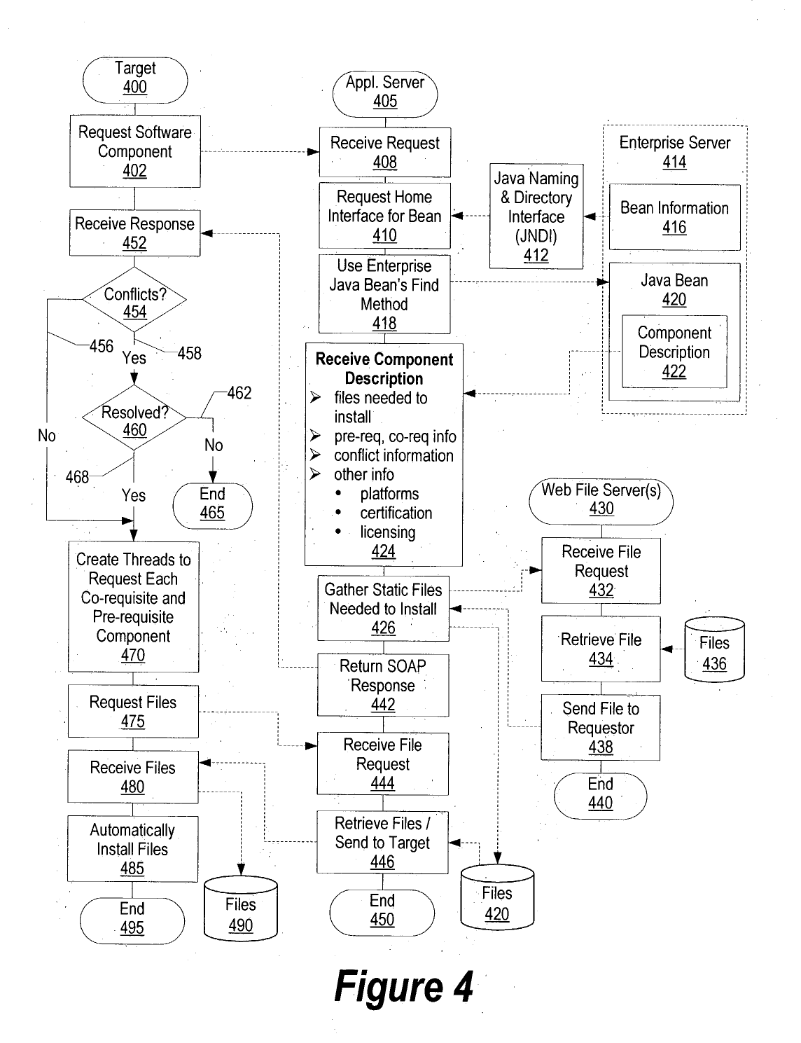

FIG. 4 shows a flowchart of a target initiated process requesting a software component and any pre-requisite or co-requisite software components. Target processing commences at 400 whereupon the target requests a software component (step 402) by sending the request to an application server.

Application server processing commences at 405 whereupon the application server receives the software component request from the target (step 408). The application server uses Java Naming and Directory Interface (JNDI) to locate the entity Java bean's home interface (step 410). The home interface is used to find the Entity Java bean that describes the requested software.

The application server uses the “getter” methods of the identified Entity Java bean 420 to retrieve component description 422 corresponding to the requested software component (step 424). The component description includes the files needed to install the component, pre-requisite components, co-requisites components, conflict information, and other information such as software and hardware platform requirements, certification information, and licensing information.

The application server gathers static files needed to install the software component (step 426) from one or more Web based file servers. Web-based file server processing commences at 430 whereupon the file server receives a component file request (step 432) from the application server. The file server retrieves the requested file (step 434) from nonvolatile storage device 436. The Web file server sends a requested file back to the application server (step 438). The application server stores receive files in nonvolatile storage device 428 so the files are available when the target computer system request the component files. Web file server processing ends at 440.

The application server returns a SOAP response to the target computer system (step 442). The SOAP response includes the information that was included in the component description. Returning to target computer system processing, the target computer receives the SOAP response from the application server (step 452). Target computer system determines whether there any conflicts involved with installing the requested software component (decision 454). If there are no conflicts, decision 454 branches to “no” branch 456 bypassing steps taken to resolve the conflict. On the other hand, if there are complex decision 454 branches to “yes” branch 458 whereupon attempts are made at resolving the conflict. A determination is made as to whether the conflicts were resolved (decision 460). If the conflicts were not resolved, decision 460 branches to “no” branch 462 whereupon target processing ends at 465. On the other hand, if the conflicts were resolved, decision 460 branches to “yes” branch 468 and processing continues.

Threads are created to request each co-requisite and pre-requisite software component (step 470). The processing described in steps 402 through 470 are repeated for each co-requisite and pre-requisite software component that is requested. Software component files are requested from the application server (step 475). The application server retrieves the requested files from nonvolatile storage area 428 and sends into the target computer system (step 446). Application server processing then ends at 450. Files corresponding to co-requisite and pre-requisite software components are also requested at step 475. Received files are stored in nonvolatile storage area 490 is accessible by the target computer system. The requested software component is automatically installed (step 485) using the received software component files. Target computer processing then ends at 495.

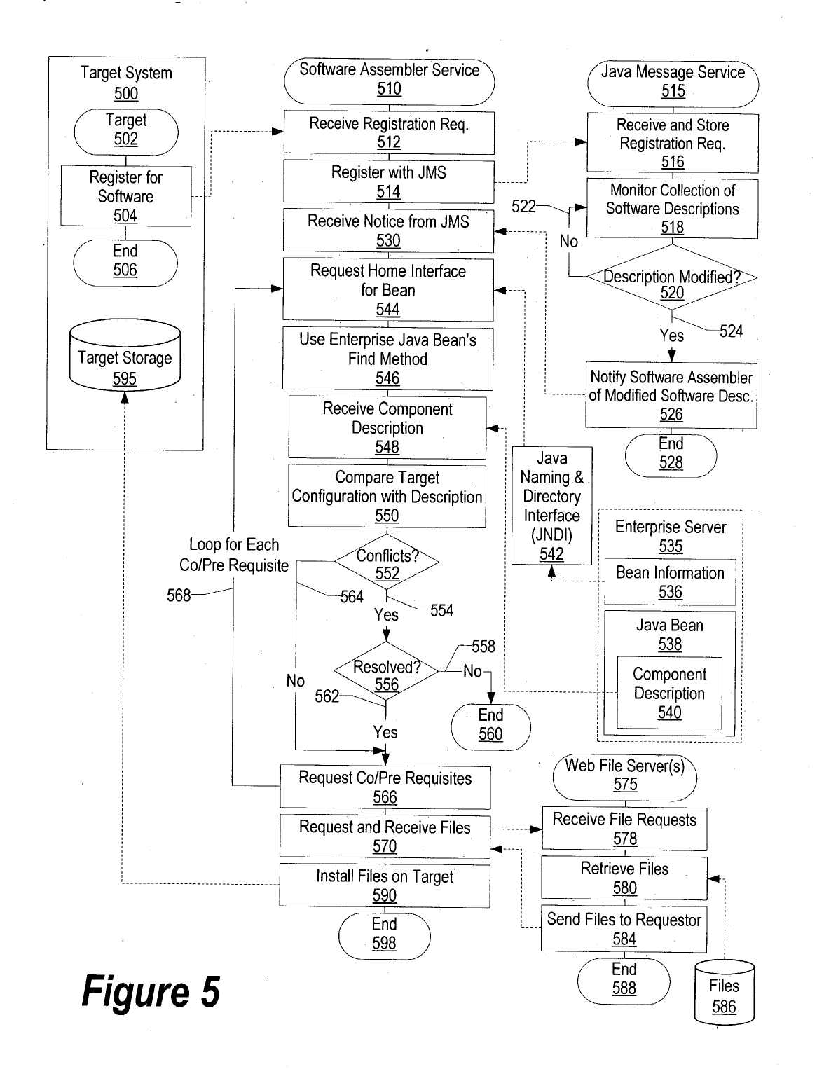

FIG. 5 shows a flowchart of a Web service initiated process monitoring software components and installing a software component and any pre-requisite or co-requisite software components. Target computer system 500 includes a process to register for software that commences at 502. The target computer system registers for software (step 504) by sending a registration request to the software assembler service. Target computer system's registration process ends at 506. During the registration step, the target computer system provides the software assembler service with information that will be used to drive an automated installation on the target computer system by the software assembler service. Information that is included in to drive the process may include a host, or server name, passwords used to access the target computer system, authentication credentials uniquely identifying the target computer system, the software component or category of software to which the target computer system is registering, and other information that may be needed by the software assembler service. Target computer system also includes nonvolatile storage device 595 and is used to store and install software component files.

The software assembler service processing commences at 510 whereupon the software assembler service receives registration request from the target computer system (step 512). The software assembler service uses a registration information to register for one or more software components with a Java Message Service that may be hosted by an enterprise application server (step 514).

Java Message Service processing commences at 515 whereupon the JMS receives and stores the registration request received from the software assembler service (step 516). The Java Message Service monitors a collection of software descriptions that are stored in Java beans accessible from the JMS (step 518). A determination is made as to whether the description corresponding to software components to which the software assembler service has registered are changed (decision 520). If the descriptions have not been changed, decision 520 branches to “no” branch 522 which loops back to continue monitoring the collection of software descriptions. This looping continues until a component to which a software assembler service has registered has its description modified. At this point, decision 520 branches to “yes” branch 524 whereupon the Java Message Service sends a message to the software assembler service notifying the service that the component description has been changed (step 526). JMS processing of the modified software description ends at 528. In one embodiment, JMS 515 continuously detects registration requests and continuously monitors the collection of software descriptions.

The software assembler service receives the notification that a component description to which the software assembler service was registered has been modified (step 530). Software assembler service requests the home interface for the Enterprise Java bean (step 544) by using the Java Naming and Directory Interface (JNDI, 542). Step 544 results in the software assembler service identifying the Enterprise Java bean corresponding to the software component. The software assembler service uses the “getter” method provided by the Enterprise Java bean that was identified in step 544 (step 546). The component description is received from the Enterprise Java bean that corresponds to the software component (step 548). The component description includes the files are needed to install software component. In addition, the component description includes conflict information, and any pre-requisite/co-requisite component information. Other information that may be included in the software component are the supportive hardware and software platforms, certification levels, and licensing information. In one embodiment, the component description also includes information identifying description information that has been modified. In this manner, it may be possible to install the modified files without having to reinstall the entire software component.

The configuration of the target computer system is compared with the description information provided by the Java bean (step 550). A determination is made based upon this comparison as to whether any conflicts exist between the target system can be component software (decision 552). If no conflicts exist, decision 552 branches to “no” branch 564 bypassing steps taken to resolve the conflict. On the other hand, if conflicts exist decision 552 branches to “yes” branch 554 whereupon attempts are made to resolve the conflict. A determination is made as to whether the conflicts were results (decision 556). If the conflicts were not able to be resolved, decision 556 branches to “no” branch 558 whereupon software assembler service processing and at 560. On the other hand, if the conflicts were able to be resolved, decision 556 branches to “yes” branch 562 and processing continues.

Any pre-requisite or co-requisite software components are requested (step 566) by looping back (loop 568) and requesting the co-requisite/pre-requisite software components. The software component files are requested (step 570) from one or more Web file servers. Web file server processing commences at 575 whereupon the request for software component files is received (step 578). The requested files are retrieved (step 580) from nonvolatile storage area 568. The retrieved files are sent from the Web file server back to the software assembler service (step 584) and Web file server processing ends at 588.

The software assembler service receives the requested in software component files (step 570). The software component files are installed (step 590) and target computer system 500 and software component files are stored on nonvolatile storage device 595 which is accessible from target computer system 500. The software assembler service accesses target system using the information that was provided by the target system during registration (see steps 504 and 512 above). Software assembler service processing then ends at 598.

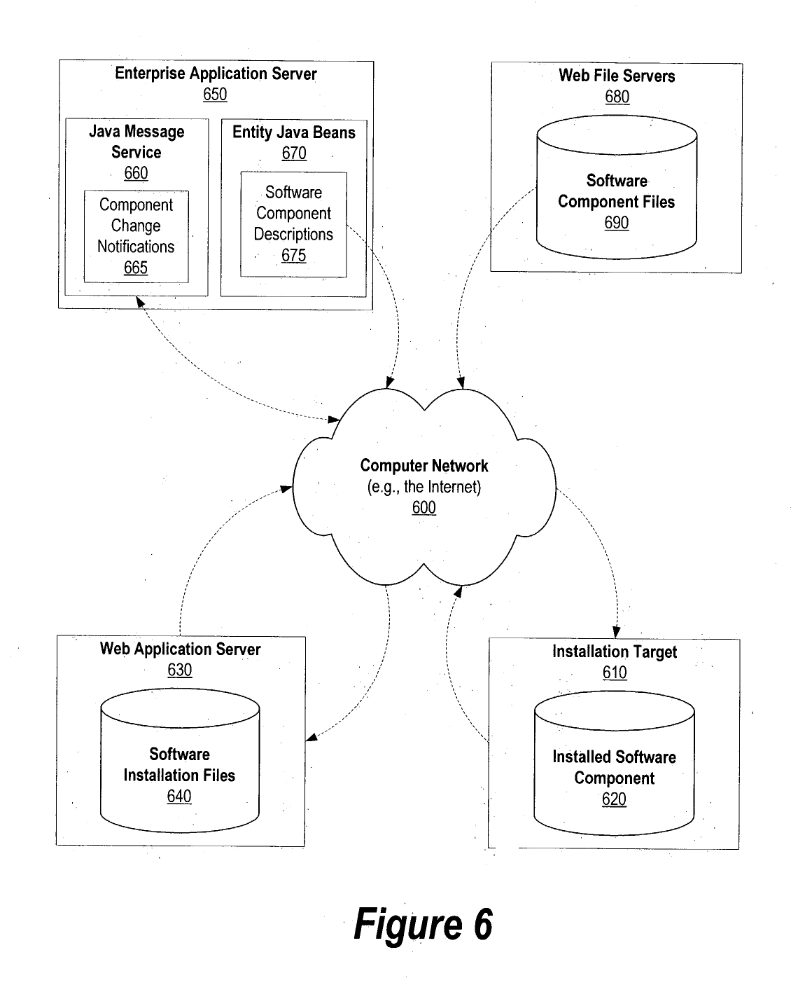

FIG. 6 shows a network diagram of network nodes that interact to provide component installation services for a target computer system. Installation target 610, Web application server 630, enterprise application server 650, and Web file servers 680 are interconnected to one another using computer network 600. An example of computer network 650 is the Internet.

In one embodiment, installation target 610 requests a software component from Web application server 630. Web application server 630 retrieves description information corresponding to the requested software component from entity Java bean 670 that includes software component descriptions 675 corresponding to the requested software component. Entity Java bean 670 is hosted on enterprise application server 650.

Web application server 630 receives the software component description that detail the component files included in the requested software component as well as conflicts, and pre-requisite/co-requisite software components. The software component description is returned to installation target 610 which uses information to receive component files and install the software component on nonvolatile storage device 620. Web application server 630 retrieves software component files 690 from Web file servers 680. Web application server 630 stores the software installation files on nonvolatile storage device 640 for transmission to installation target 610.

In another embodiment, installation target 610 registers for a software component with Web application server 630. Web application server 630, in turn, registers for the software component with enterprise application server 650, using Java message service 660 provided by the enterprise application server. When the registered component is changed, the Java message service sends component change notification 665 to Web application server 630. Web application server 630 gathers the component files from Web file server 680 and automatically installs the software component on installation target 610 using information was provided by the installation target during registration process.

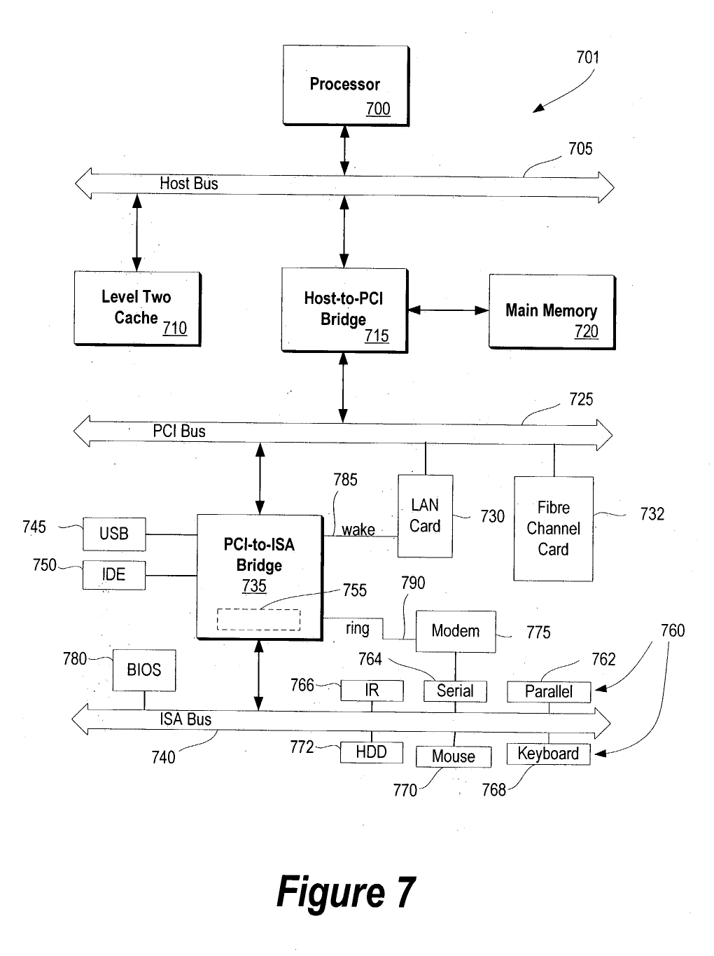

FIG. 7 illustrates information handling system 701 which is a simplified example of a computer system capable of performing the invention described herein. Computer system 701 includes processor 700 which is coupled to host bus 705. A level two (L2) cache memory 710 is also coupled to the host bus 705. Host-to-PCI bridge 715 is coupled to main memory 720, includes cache memory and main memory control functions, and provides bus control to handle transfers among PCI bus 725, processor 700, L2 cache 710, main memory 720, and host bus 705. PCI bus 725 provides an interface for a variety of devices including, for example, LAN card 730. PCI-to-ISA bridge 735 provides bus control to handle transfers between PCI bus 725 and ISA bus 740, universal serial bus (USB) functionality 745, IDE device functionality 750, power management functionality 755, and can include other functional elements not shown, such as a real-time clock (RTC), DMA control, interrupt support, and system management bus support. Peripheral devices and input/output (I/O) devices can be attached to various interfaces 760 (e.g., parallel interface 762, serial interface 764, infrared (IR) interface 766, keyboard interface 768, mouse interface 770, and fixed disk (HDD) 772) coupled to ISA bus 740. Alternatively, many I/O devices can be accommodated by a super I/O controller (not shown) attached to ISA bus 740.

BIOS 780 is coupled to ISA bus 740, and incorporates the necessary processor executable code for a variety of low-level system functions and system boot functions. BIOS 780 can be stored in any computer readable medium, including magnetic storage media, optical storage media, flash memory, random access memory, read only memory, and communications media conveying signals encoding the instructions (e.g., signals from a network). In order to attach computer system 701 to another computer system to copy files over a network, LAN card 730 is coupled to PCI bus 725 and to PCI-to-ISA bridge 735. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of installing software components over a computer network, said method comprising:
receiving, over the computer network, a request from an installation target computer system, the request identifying a software component;
locating an interface corresponding to the requested software component;
retrieving a component description by using the identified interface;
analyzing the component description, the analysis resulting in an identification of one or more component files used to install the requested software component; and
returning a response relating to the requested software component to the installation target computer system.

2. The method as described in claim 1 wherein the software component request includes a SOAP request and wherein the response includes a SOAP response.

3. The method as described in claim 1 further comprising:
requesting, over the computer network, the component files from a file server;
receiving the requested component files; and
transmitting the received component files to the installation target computer system.

4. The method as described in claim 1 wherein the component description includes identifications of one or more co-requisite software components, the method further comprising:
returning the co-requisite software component identifiers with the response;
receiving, over the computer network, a second request from an installation target computer system, the second request identifying one of the co-requisite software components;
locating a second interface corresponding to the requested co-requisite software component;
retrieving a second component description by using the second interface;
analyzing the second component description, the analysis resulting in an identification of one or more co-requisite component files used to install the requested co-requisite software component; and
returning a response relating to the second requested software component to the installation target computer system.

5. The method as described in claim 4 wherein at least one of the co-requisite files is a pre-requisite file.

6. The method as described in claim 1 wherein the locating further comprises:
requesting a home interface corresponding to an Enterprise Java Bean that relates to the requested software component.

7. The method as described in claim 1 wherein the retrieving of the component description further comprises:
calling an Enterprise Java Bean find method, wherein the Enterprise Java Bean includes the located interface.

8. The method as described in claim 1 wherein the software component request includes a registration request, the method further comprising:
registering the request with a Java Message Service, wherein the request corresponds to the requested software component; and
receiving a notification from the Java Message Service, the notification indicating that the description corresponding to the requested software component has been changed.

9. The method as described in claim 8, wherein the registration request includes installation target access information, the method further comprising:
accessing the installation target computer system using the installation target access information in response to receiving the notification; and
installing, over the computer network, one or more of the component files on the installation target computer system.

10. An information handling system comprising:
one or more processors;
a memory accessible by the processors;
one or more nonvolatile storage devices accessible by the processors;
a network interface connecting the information handling system to a computer network; and
an installation tool for installing component files over the computer network, the installation tool including:
receiving logic for receiving a request from an installation target computer system over the computer network, the request identifying a software component;
location logic for locating an interface corresponding to the requested software component;
retrieval logic for retrieving a component description by using the identified interface;
analysis logic for analyzing the component description, the analysis resulting in an identification of one or more component files used to install the requested software component; and
transmittal logic for returning a response relating to the requested software component to the installation target computer system.

11. The information handling system as described in claim 10 wherein the software component request includes a SOAP request and wherein the response includes a SOAP response.

12. The information handling system as described in claim 10 further comprising:
requesting logic for using the network interface to request the component files from a file server;
network logic for receiving the requested component files from the file server; and
transmittal logic for transmitting the received component files to the installation target computer system.

13. The information handling system as described in claim 10 wherein the location logic further comprises:
request logic for requesting a home interface corresponding to an Enterprise Java Bean that relates to the requested software component.

14. The information handling system as described in claim 10 wherein the retrieval logic for retrieving the component description further comprises:
interface logic for calling an Enterprise Java Bean find information handling system, wherein the Enterprise Java Bean includes the located interface.

15. The information handling system as described in claim 10 wherein the software component request includes a registration request, the information handling system further comprising:
registration logic for registering the request with a Java Message Service, wherein the request corresponds to the requested software component; and
network interface logic for receiving a notification from the Java Message Service, the notification indicating that the description corresponding to the requested software component has been changed.

16. The information handling system as described in claim 15, wherein the registration request includes installation target access information, the information handling system further comprising:
access logic for accessing the installation target computer system using the installation target access information in response to receiving the notification; and
installation logic for installing, over the computer network, one or more of the component files on the installation target computer system.

17. A computer program product stored in a computer operable media for installing software components over a computer network, said computer program product comprising:
means for receiving, over the computer network, a request from an installation target computer system, the request identifying a software component;
means for locating an interface corresponding to the requested software component;
means for retrieving a component description by using the identified interface;
means for analyzing the component description, the analysis resulting in an identification of one or more component files used to install the requested software component; and
means for returning a response relating to the requested software component to the installation target computer system.

18. The computer program product as described in claim 17 wherein the software component request includes a SOAP request and wherein the response includes a SOAP response.

19. The computer program product as described in claim 17 further comprising:
means for requesting, over the computer network, the component files from a file server;
means for receiving the requested component files; and
means for transmitting the received component files to the installation target computer system.

20. The computer program product as described in claim 17 wherein the component description includes identifications of one or more co-requisite software components, the computer program product further comprising:
means for returning the co-requisite software component identifiers with the response;
means for receiving, over the computer network, a second request from an installation target computer system, the second request identifying one of the co-requisite software components;
means for locating a second interface corresponding to the requested co-requisite software component;
means for retrieving a second component description by using the second interface;
means for analyzing the second component description, the analysis resulting in an identification of one or more co-requisite component files used to install the requested co-requisite software component; and
means for returning a response relating to the second requested software component to the installation target computer system.

21. The computer program product as described in claim 20 wherein at least one of the co-requisite files is a pre-requisite file.

22. The computer program product as described in claim 17 wherein the means for locating further comprises:
means for requesting a home interface corresponding to an Enterprise Java Bean that relates to the requested software component.

23. The computer program product as described in claim 17 wherein the means for retrieving of the component description further comprises:
means for calling an Enterprise Java Bean find computer program product, wherein the Enterprise Java Bean includes the located interface.

24. The computer program product as described in claim 17 wherein the software component request includes a registration request, the computer program product further comprising:
means for registering the request with a Java Message Service, wherein the request corresponds to the requested software component; and
means for receiving a notification from the Java Message Service, the notification indicating that the description corresponding to the requested software component has been changed.

25. The computer program product as described in claim 24, wherein the registration request includes installation target access information, the computer program product further comprising:
means for accessing the installation target computer system using the installation target access information in response to receiving the notification; and
means for installing, over the computer network, one or more of the component files on the installation target computer system.

26. A method of installing software components over a computer network, said method comprising:
receiving, over the computer network, a request from an installation target computer system, the request identifying a software component;
locating an interface corresponding to the requested software component;
retrieving a component description by using the identified interface, the component description including identifications of one or more co-requisite software components;
analyzing the component description, the analysis resulting in an identification of one or more component files used to install the requested software component;
returning a response relating to the requested software component to the installation target computer system, the response including the co-requisite software component identifiers;
receiving, over the computer network, a second request from an installation target computer system, the second request identifying one of the co-requisite software components;
locating a second interface corresponding to the requested co-requisite software component;
retrieving a second component description by using the second interface;
analyzing the second component description, the analysis resulting in an identification of one or more co-requisite component files used to install the requested co-requisite software component; and
returning a response relating to the second requested software component to the installation target computer system.

27. A method of installing software components over a computer network, said method comprising:
receiving, over the computer network, a registration request from an installation target computer system, the registration request identifying at least one software component;
locating an interface corresponding to the requested software component;
registering the request with a Java Message Service, wherein the request corresponds to the requested software component;
receiving a notification from the Java Message Service, the notification indicating that the description corresponding to the requested software component has been changed;
retrieving a component description by using the identified interface;
analyzing the component description, the analysis resulting in an identification of one or more component files used to install the requested software component; and
installing the component files on the installation target computer system.

28. An information handling system comprising:
one or more processors;
a memory accessible by the processors;
one or more nonvolatile storage devices accessible by the processors;
a network interface connecting the information handling system to a computer network; and
an installation tool for installing component files over the computer network, the installation tool including:
receiving logic for receiving a request from an installation target computer system over the computer network, the request identifying a software component;
location logic for locating an interface corresponding to the requested software component;
retrieval logic for retrieving a component description by using the identified interface;
analysis logic for analyzing the component description, the analysis resulting in an identification of one or more component files used to install the requested software component;
transmittal logic for returning a response relating to the requested software component to the installation target computer system.
registration logic for registering the request with a Java Message Service, wherein the request corresponds to the requested software component and wherein the request includes installation target access information;
network interface logic for receiving a notification from the Java Message Service, the notification indicating that the description corresponding to the requested software component has been changed;
access logic for accessing the installation target computer system using the installation target access information in response to receiving the notification; and
installation logic for installing, over the computer network, one or more of the component files on the installation target computer system

29. A computer program product stored in a computer operable media for installing software components over a computer network, said computer program product comprising:
receiving, over the computer network, a request from an installation target computer system, the request identifying a software component;
locating an interface corresponding to the requested software component;
retrieving a component description by using the identified interface, the component description including identifications of one or more co-requisite software components;
analyzing the component description, the analysis resulting in an identification of one or more component files used to install the requested software component;
returning a response relating to the requested software component to the installation target computer system, the response including the co-requisite software component identifiers;
receiving, over the computer network, a second request from an installation target computer system, the second request identifying one of the co-requisite software components;
locating a second interface corresponding to the requested co-requisite software component;
retrieving a second component description by using the second interface;
analyzing the second component description, the analysis resulting in an identification of one or more co-requisite component files used to install the requested co-requisite software component; and
returning a response relating to the second requested software component to the installation target computer system.

30. A computer program product stored in a computer operable media for installing software components over a computer network, said computer program product comprising:
receiving, over the computer network, a registration request from an installation target computer system, the registration request identifying at least one software component;
locating an interface corresponding to the requested software component;
registering the request with a Java Message Service, wherein the request corresponds to the requested software component;
receiving a notification from the Java Message Service, the notification indicating that the description corresponding to the requested software component has been changed;
retrieving a component description by using the identified interface;
analyzing the component description, the analysis resulting in an identification of one, or more component files used to install the requested software component; and
installing the component files on the installation target computer system.
